(19) United States
(12) Patent Application Publication
(10) Pub. No.: US 2022/0373766 A1
(43) Pub. Date: Nov. 24, 2022

(54) Illumination system and projection device

(71) Applicant: Coretronic Corporation, Hsin-Chu (TW)

(72) Inventors: JIA-HAO ZHOU, Hsin-Chu (TW); CHUNG-JEN OU, Hsin-Chu (TW); JUI-YI WU, Hsin-Chu (TW); CHIH-HUNG LU, Hsin-Chu (TW)

(21) Appl. No.: 17/745,909

(22) Filed: May 17, 2022

(30) Foreign Application Priority Data
May 21, 2021 (CN) 202110555408.5

(51) Int. Cl. G02B 7/10; G02B 3/10; G02B 9/10; G03B 3/10

(52) U.S. Cl. CPC G02B 7/10; G02B 3/10; G02B 9/10; G03B 3/10

(57) ABSTRACT

An illumination system includes an excitation light source, a first variable focus lens, a second variable focus lens, and a control unit. The excitation light source is adapted to provide an excitation light beam. The first variable focus lens is disposed on a transmission path of the excitation light beam. The first variable focus lens is located between the excitation light source and the second variable focus lens. The second variable focus lens is adapted to receive the excitation light beam exited from the first variable focus lens. The control unit is electrically connected to the first variable focus lens and the second variable focus lens, and is adapted to synchronously adjust focal lengths of the first variable focus lens and the second variable focus lens. A projection device including the above-mentioned illumination system of the invention is further provided.

### CROSS-REFERENCE TO RELATED APPLICATION

This application claims the priority benefit of China application 202110555408.5, filed on 2021 May 21. The entirety of the above-mentioned patent application is hereby incorporated by reference herein and made a part of this specification.

### FIELD OF THE INVENTION

The invention relates to a display device, and more particularly to an illumination system and a projection device using the same.

### BACKGROUND OF THE INVENTION

The type of light source used in projection devices has evolved from ultra high pressure mercury lamps (UHP lamps), light emitting diodes (LEDs) to laser diodes (LDs) with the market demand for projection device brightness, color saturation, service life, non-toxic environmental protection, etc.

In a conventional projection device using a laser diode, the laser diode provides an excitation light beam to excite the phosphor layer on the phosphor wheel to generate a fluorescent light beam. However, due to the high coherence of the laser, the excitation light beam is prone to interference, resulting in randomly distributed laser speckles with mixed brightness and darkness.

The method currently used to reduce the laser speckles is to add a diffusion plate or change the focal length. Vibrating the diffusion plate may continuously change the position of a light spot, which reduces the laser speckles and improves the light uniformity. However, the use of diffusion plate makes it difficult to concentrate the light beam.

On the other hand, the use of a variable focus lens may also continuously change the position of the light spot, which reduces the laser speckles and improves the light uniformity. However, when the light beam needs to be kept in a plane wave (that is, parallel light) state, a single variable focus lens would destroy the wave front travel mode, resulting in poor imaging quality.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides an illumination system, which may increase the light uniformity and reduce laser speckle.

The invention provides a projection device, which may increase the light uniformity and improve the imaging quality.

Other advantages and objects of the invention may be further illustrated by the technical features broadly embodied and described as follows.

In order to achieve one or a portion of or all of the objects or other objects, an illumination system provided in an embodiment of the invention includes an excitation light source, a first variable focus lens, a second variable focus lens, and a control unit. The excitation light source is adapted to provide an excitation light beam. The first variable focus lens is disposed on a transmission path of the excitation light beam. The second variable focus lens is disposed on the transmission path of the excitation light beam, and the first variable focus lens is located between the excitation light source and the second variable focus lens. The second variable focus lens is adapted to receive the excitation light beam exited from the first variable focus lens. The control unit is electrically connected to the first variable focus lens and the second variable focus lens, and is adapted to synchronously adjust focal lengths of the first variable focus lens and the second variable focus lens.

In order to achieve one or a portion of or all of the objects or other objects, a projection device provided in an embodiment of the invention includes a light valve, a projection lens and the above-mentioned illumination system. The above-mentioned illumination system further includes a wavelength conversion wheel, which is disposed on the transmission path of the excitation light beam passing through the second variable focus lens, and is adapted to convert the excitation light beam into a converted light beam. An illumination light beam includes the excitation light beam and the converted light beam. The light valve is disposed on a transmission path of the illumination light beam, and is adapted to convert the illumination light beam into an image light beam. The projection lens is disposed on a transmission path of the image light beam and is adapted to allow the image light beam to pass through.

In the illumination system of the embodiment of the invention, the control unit is electrically connected to the first variable focus lens and the second variable focus lens, and is adapted to synchronously adjust focal lengths of the first variable focus lens and the second variable focus lens. Therefore, when the excitation light beam passes through the first variable focus lens, a position of a light spot may be continuously changed due to the continuous change of the focal length, so that the laser speckle is reduced and the light uniformity is increased. At the same time, the excitation light beam passing through the first variable focus lens would be adjusted from parallel light to divergent light or convergent light due to the change in focal length. The focal length of the second variable focus lens is adjusted according to the current focal length of the first variable focus lens, so that the excitation light beam exited from the first variable focus lens and passing through the second variable focus lens may be adjusted back to parallel light to achieve an effect of light compensation. Since the projection device of the embodiment of the invention uses the above-mentioned illumination system, the light uniformity may be increased, and the imaging quality may be improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an illumination system of one embodiment of the invention;

FIG. 2 is a schematic diagram of a form transformation of a first variable focus lens or a second variable focus lens of one embodiment of the invention;

FIG. 3A is a schematic diagram of a focal length adjustment of a first variable focus lens and a second variable focus lens of one embodiment of the invention;

FIG. 3B to FIG. 3C are schematic diagrams of a focal length adjustment of a first variable focus lens and a second variable focus lens of another embodiment of the invention;

FIG. 4 is a schematic diagram of a light spot formed by an excitation light beam on a wavelength conversion wheel of the embodiment; and

FIG. 5 is a block diagram of a projection device of one embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

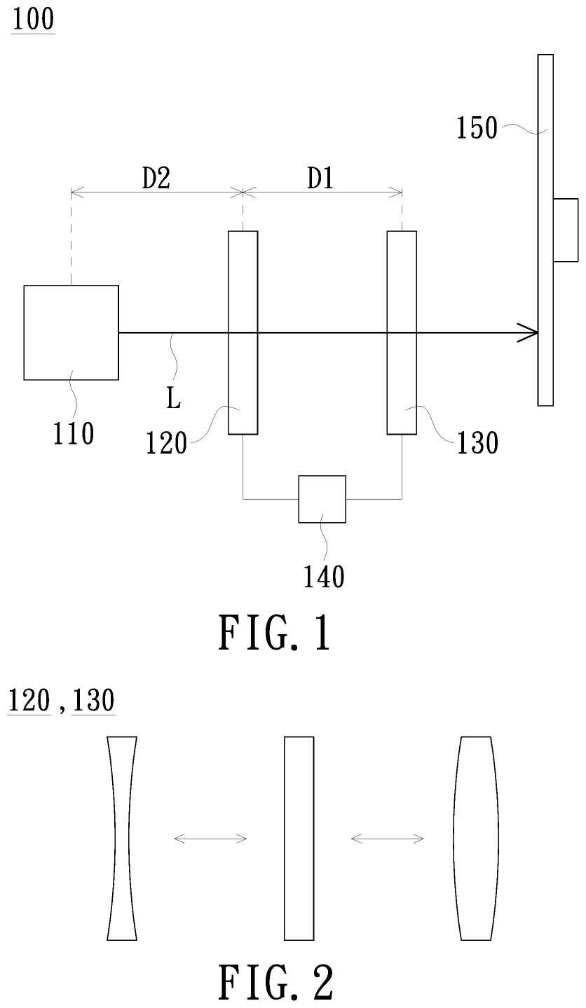

FIG. 1 is a schematic diagram of an illumination system of one embodiment of the invention. FIG. 2 is a schematic diagram of a form transformation of a first variable focus lens or a second variable focus lens of one embodiment of the invention. Referring to FIG. 1 and FIG. 2, the illumination system 100 of the embodiment includes an excitation light source 110, a first variable focus lens 120, a second variable focus lens 130, and a control unit 140. The excitation light source 110 is adapted to provide an excitation light beam L. The first variable focus lens 120 is disposed on a transmission path of the excitation light beam L. The second variable focus lens 130 is disposed on the transmission path of the excitation light beam L, and the first variable focus lens 120 is located between the excitation light source 110 and the second variable focus lens 130. The second variable focus lens 130 is adapted to receive the excitation light beam L exited from the first variable focus lens 120. Specifically, after being emitted from the excitation light source 110, the excitation light beam L first passes through the first variable focus lens 120, and then passes through the second variable focus lens 130. The positions of the first variable focus lens 120 and the second variable focus lens 130 may be interchanged, and the invention does not limit the relative positions of the first variable focus lens 120 and the second variable focus lens 130 in the illumination system 100. The control unit 140 is electrically connected to the first variable focus lens 120 and the second variable focus lens 130, and is adapted to synchronously adjust focal lengths of the first variable focus lens 120 and the second variable focus lens 130.

The excitation light source 110 is, for example, a laser light source or other light sources that may provide an excitation light beam L with high coherence. In the embodiment, the excitation light beam L emitted from the excitation light source 110 is parallel light and is transmitted to the first variable focus lens 120.

Regarding the first variable focus lens 120 and the second variable focus lens 130, the purpose of changing the focal length is achieved by changing a curvature of a film or an interface (changing the shape of the lens surface), or by changing the characteristics of a material itself. As shown in FIG. 2, taking the first variable focus lens 120 as an example, the first variable focus lens 120 may be arbitrarily switched between a form of flat lens, a form of concave lens, and a form of convex lens. Depending on the focal length, the light beam passing through the first variable focus lens 120 is converted into parallel light, convergent light or divergent light. The type of the first variable focus lens 120 includes, for example, a liquid crystal lens, a hydraulic lens, a mechanically driven lens, an electrowetting lens, etc., but is not limited thereto. The above description of the first variable focus lens 120 is also applicable to the second variable focus lens 130, and in the embodiment, the first variable focus lens 120 and the second variable focus lens 130 may be selected from different types of variable focus lenses.

Under the configuration of the embodiment, a distance D1 between the first variable focus lens 120 and the second variable focus lens 130 is, for example, fixed, and a distance D2 between the excitation light source 110 and the first variable focus lens 120 is also fixed, for example. Since both the first variable focus lens 120 and the second variable focus lens 130 may change the focal length, it is not necessary to change the focal length by moving back and forth on the transmission path of the excitation light beam L. Therefore, compared with the general lens used in the known illumination system, a volume of the illumination system 100 of the embodiment is smaller. When the distance D1 is fixed, the variables may also be reduced, and a quality of the excitation light beam L may be more stable.

On the other hand, the first variable focus lens 120 is confocal with the second variable focus lens 130, for example, but it is not limited thereto. A conjugate focus may be adjusted between the first variable focus lens 120 and the second variable focus lens 130, between the excitation light source 110 and the first variable focus lens 120, or on a side of the second variable focus lens 130 facing away from the first variable focus lens 120. In another embodiment, the focus of the first variable focus lens 120 and the focus of the second variable focus lens 130 may be adjusted to be at different positions.

Specifically, the function of the first variable focus lens 120 is to continuously change the focal length, so that a position of a light spot generated by the excitation light beam L would be continuously changed after passing through the first variable focus lens 120, resulting in a reduction of laser speckle and an increase of light uniformity. The function of the second variable focus lens 130 is that when the excitation light beam L passing through the first variable focus lens 120 is adjusted from parallel light to divergent light or convergent light due to a change in focal length, the second variable focus lens 130 may adjust the excitation light beam L by changing its focal length, so that the excitation light beam L exited from the first variable focus lens 120 and passing through the second variable focus lens 130 is then adjusted back to parallel light to achieve an effect of light compensation. In this way, the light uniformity may be increased and the image quality may be maintained.

The first variable focus lens 120 and the second variable focus lens 130 should continuously change their focal lengths to achieve the effect of parallel light compensation. The control unit 140 in the embodiment is adapted to synchronously adjust the focal lengths of the first variable focus lens 120 and the second variable focus lens 130. In order to meet the requirements of the invention, the control unit 140 preferably synchronously and respectively adjusts the focal lengths of the first variable focus lens 120 and the second variable focus lens 130. The control unit 140 giving different signals to the first variable focus lens 120 and the second variable focus lens 130 at different time sequences to synchronously change the form of the first variable focus lens 120 and the second variable focus lens 130 to adjust the focal length will be described in detail below.

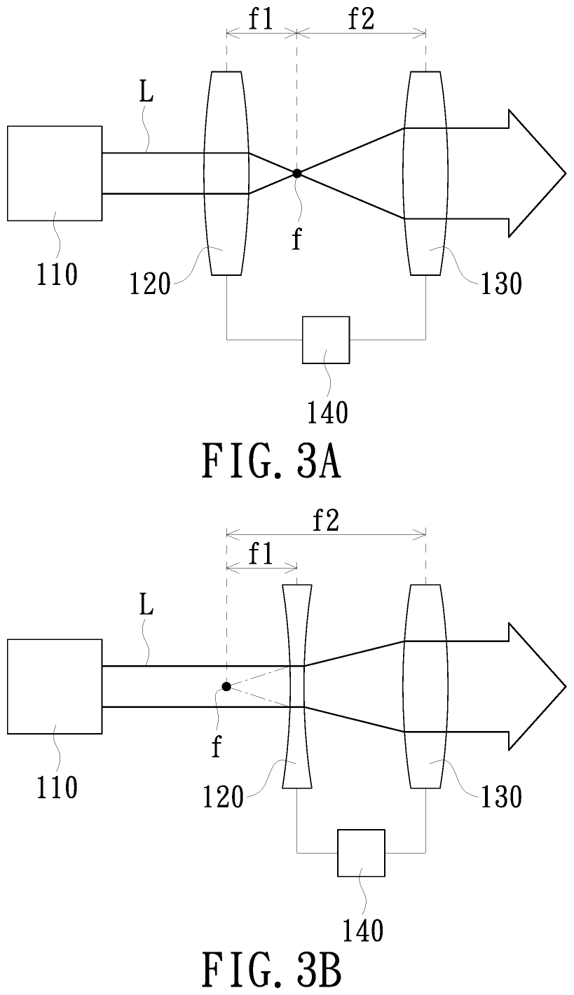

FIG. 3A is a schematic diagram of a focal length adjustment of a first variable focus lens and a second variable focus lens of one embodiment of the invention. Referring to FIG. 3A, a diopter of the first variable focus lens 120 and a diopter of the second variable focus lens 130 are both positive. That is, both the first variable focus lens 120 and the second variable focus lens 130 are in the form of convex lenses, and a focus f is located between the first variable focus lens 120 and the second variable focus lens 130. In a time sequence, the excitation light beam L is adjusted to convergent light after passing through the first variable focus lens 120, and then the convergent light becomes divergent light after passing through the focal point f and is transmitted to the second variable focus lens 130. Subsequently, the excitation light beam L is adjusted back to parallel light by the convergence after passing through the second variable focus lens 130. Since a focal length f2 is greater than a focal length fl, the light beam after passing through the second variable focus lens 130 is enlarged compared with the original excitation light beam. In other words, a light spot area of the excitation light beam L projected by the excitation light source 110 is smaller than a light spot area of the excitation light beam L after passing through the first variable focus lens 120 and the second variable focus lens 130. On the contrary, in another time sequence, when the focus f is located between the first variable focus lens 120 and the second variable focus lens 130 and the focal length f2 is smaller than the focal length fl, the light beam after passing through the second variable focus lens 130 is narrowed compared with the original excitation light beam. In other words, the light spot area of the excitation light beam L projected by the excitation light source 110 is larger than the light spot area of the excitation light beam L after passing through the first variable focus lens 120 and the second variable focus lens 130.

FIG. 3B to FIG. 3C are schematic diagrams of a focal length adjustment of a first variable focus lens and a second variable focus lens of another embodiment of the invention. Referring to FIG. 3B, in a first time sequence of another embodiment, the diopter of the first variable focus lens 120 is negative and the diopter of the second variable focus lens 130 is positive. That is, the first variable focus lens 120 is in the form of a concave lens, the second variable focus lens 130 is in the form of a convex lens, and the focus f is located between the excitation light source 110 and the first variable focus lens 120. The excitation light beam L is adjusted to divergent light after passing through the first variable focus lens 120 and is transmitted to the second variable focus lens 130. Subsequently, the excitation light beam L is adjusted back to parallel light by the convergence after passing through the second variable focus lens 130. Since the focal length f2 is greater than the focal length fl, the light beam after passing through the second variable focus lens 130 is enlarged compared with the original excitation light beam. In other words, the light spot area of the excitation light beam L projected by the excitation light source 110 is smaller than the light spot area of the excitation light beam L after passing through the first variable focus lens 120 and the second variable focus lens 130.

Referring to FIG. 3C, in another time sequence, the control unit 140 gives different signals to change the diopter of the first variable focus lens 120 to be positive and to change the diopter of the second variable focus lens 130 to be negative. That is, the first variable focus lens 120 is in the form of a convex lens, the second variable focus lens 130 is in the form of a concave lens, and the focus f is located on a side of the second variable focus lens 130 facing away from the first variable focus lens 120. The excitation light beam L is adjusted to convergent light after passing through the first variable focus lens 120, and is transmitted to the second variable focus lens 130. Subsequently, the excitation light beam L is adjusted back to parallel light by the divergence after passing through the second variable focus lens 130. Since the focal length f2 is smaller than the focal length fl, the light beam after passing through the second variable focus lens 130 is narrowed compared with the original excitation light beam. In other words, the light spot area of the excitation light beam L projected by the excitation light source 110 is larger than the light spot area of the excitation light beam L passing through the first variable focus lens 120 and the second variable focus lens 130.

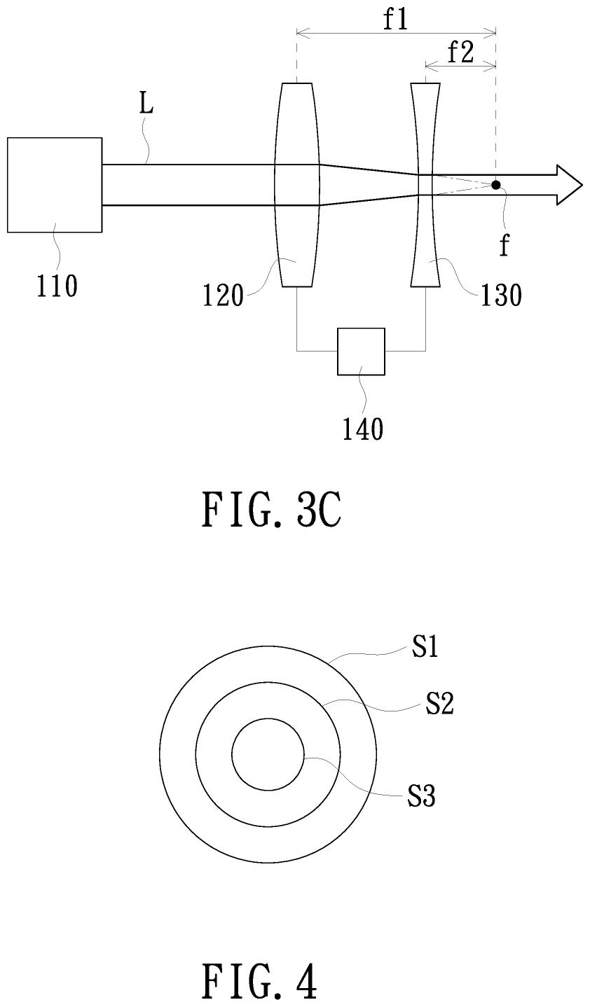

It can be seen from the above that by synchronously and respectively adjusting the focal lengths of the first variable focus lens 120 and the second variable focus lens 130, the control unit 140 may enlarge or narrow the excitation light beam L while maintaining parallel light at different time sequences, so that the light spot position is continuously changed, thereby reducing the laser speckle and increasing the light uniformity. FIG. 4 is a schematic diagram of a light spot formed by an excitation light beam on a wavelength conversion wheel of the embodiment. Referring to FIG. 1 and FIG. 4, the illumination system 100 of the embodiment further includes, for example, a wavelength conversion wheel 150, which is disposed on the transmission path of the excitation light beam L passing through the second variable focus lens 130 and is adapted to convert the excitation light beam L into a converted light beam. A wavelength conversion material used in the wavelength conversion wheel 150 includes, for example, phosphor in glass (PIG), phosphor in ceramic (PIC), polycrystal phosphor sheet, single crystal phosphor sheet, or phosphor in silicon (PIS), etc., but is not limited thereto. In addition, a light spot shape of the excitation light beam L provided by the excitation light source 110 of the embodiment is, for example, circular, but it is not limited thereto. As shown in FIG. 4, a light spot Si is formed by the enlarged excitation light beam L on the wavelength conversion wheel 150, a light spot S2 is formed by the normal excitation light beam L on the wavelength conversion wheel 150, and a light spot S3 is formed by the narrowed excitation light beam L on the wavelength conversion wheel 150. Among them, the light spot S3 has the highest light uniformity due to the superposition of the light spots Si to S3 within the area range of the light spot S3,. It should be noted that the “enlarged” and “narrowed” referred to here are not a single fixed size state, but a linear change between continuous ranges, and the light spots Si to S3 are only illustrative explanations. The time sequential and synchronous adjustment of the first variable focus lens 120 and the second variable focus lens 130 produces continuous changes in the size of the light spot, which may eliminate laser speckle and increase the light uniformity of the excitation beam L.

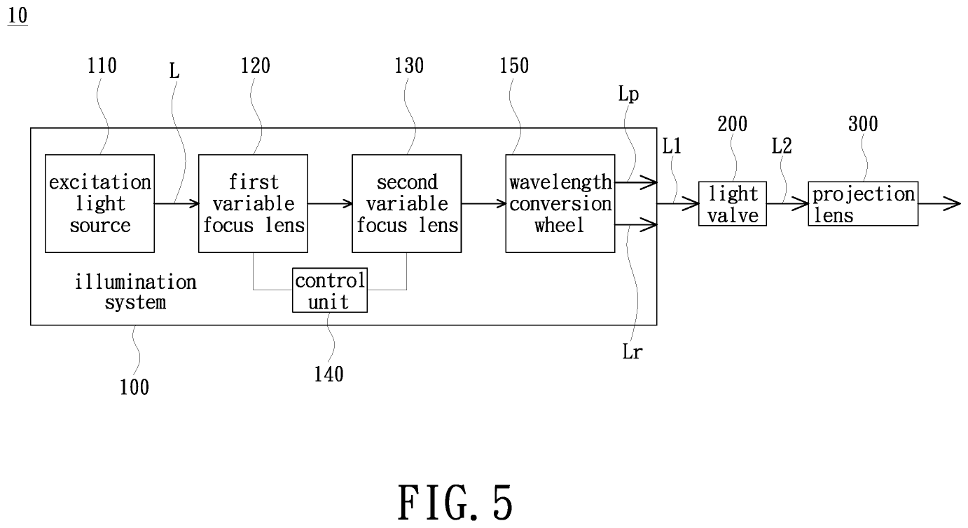

FIG. 5 is a block diagram of a projection device of one embodiment of the invention. Referring to FIG. 5, the projection device 10 of the embodiment includes an illumination system 10, a light valve 200, and a projection lens 300. The illumination system 10 is adapted to provide an illumination light beam L1. The light valve 200 is disposed on a transmission path of the illumination light beam L1 and is adapted to convert the illumination light beam L1 into an image light beam L2. The projection lens 300 is disposed on a transmission path of the image light beam L2 and is adapted to project the image light beam L2 onto a screen, and then form an image frame on the screen.

The light valve 200 may be a transmissive light valve or a reflective light valve, in which the transmissive light valve may be a transmissive liquid crystal panel, and the reflective light valve may be a digital micro-mirror device (DMD), a liquid crystal display (LCD), a liquid crystal on silicon panel (LCoS panel), a transparent liquid crystal panel, an electro-optical modulator, a magneto-optic modulator, and an acousto-optic modulator (AOM), but not limited thereto. According to different design requirements, the quantity of light valve 200 may be one or more.

The projection lens 300 includes, for example, a combination of one or more optical lenses having diopter, such as various combinations of non-planar lenses including biconcave lenses, lenticular lenses, meniscus lenses, convex and concave lenses, plano-convex lenses, and plano-concave lenses. In an embodiment, the projection lens 300 may also include a planar optical lens. The invention does not limit the type and kind of projection lens 300.

The wavelength conversion wheel 150 includes a conversion region and an optical region (not shown). The optical region may be a reflection region or a transmission region. When the excitation light beam L is irradiated on the wavelength conversion wheel 150, the conversion region is adapted to convert the excitation light beam L into a converted light beam Lp, and a wavelength of the converted light beam Lp is different from a wavelength of the excitation light beam L. When the optical region is the reflection region, it is adapted to reflect the excitation light beam L, or when the optical region is the transmission region, it is adapted to allow the excitation light beam L to pass through. That is, the excitation light beam L leaving the wavelength conversion wheel 150 via the optical region is the excitation light beam Lr. The illumination light beam L1 includes the converted light beam Lp and the excitation light beam Lr. The illumination system 100 may further include other optical elements to transmit the illumination light beam L1 to the light valve 200.

Since the illumination system 100 may increase the light uniformity of the illumination light beam L1 and eliminate laser speckle, the projection device 10 using the illumination system 100 may also increase the light uniformity and improve the imaging quality of the image light beam L2 projected to the screen.

In summary, in the illumination system of the embodiment of the invention, the control unit is electrically connected to the first variable focus lens and the second variable focus lens, and is adapted to synchronously adjust focal lengths of the first variable focus lens and the second variable focus lens according to the time sequence. Therefore, when the excitation light beam passes through the first variable focus lens, a position of a light spot may be continuously changed due to the continuous change of the focal length, so that the laser speckle is reduced and the light uniformity is increased. At the same time, the excitation light beam passing through the first variable focus lens would be adjusted from parallel light to divergent light or convergent light due to the change in focal length. The focal length of the second variable focus lens is adjusted according to the current focal length of the first variable focus lens, so that the excitation light beam exited from the first variable focus lens and passing through the second variable focus lens may be adjusted back to parallel light to achieve an effect of light compensation. Since the projection device of the embodiment of the invention uses the above-mentioned illumination system, the light uniformity may be increased, and the imaging quality may be improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated.

Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first variable focus lens, the second variable focus lens, and the first time sequence are only used for distinguishing various elements and do not limit the number of the elements.

### DESCRIPTION OF REFERENCE SIGNS

10: projection device
100: illumination system
110: excitation light source
120: first variable focus lens
130: second variable focus lens
140: control unit
150: wavelength conversion wheel
200: light valve
300: projection lens
D: distance
f: focus
fl [symbol] f2: focal length
L: excitation light beam
L1: illumination light beam
L2: image light beam
Lp: converted light beam
Lr: reflected excitation light beam
S1 [symbol] S2 [symbol] S3: light spot.

What is claimed is:

1. An illumination system, comprising an excitation light source, a first variable focus lens, a second variable focus lens, and a control unit, wherein:
the excitation light source is adapted to provide an excitation light beam;
the first variable focus lens is disposed on a transmission path of the excitation light beam;
the second variable focus lens is disposed on the transmission path of the excitation light beam, the first variable focus lens is located between the excitation light source and the second variable focus lens, and the second variable focus lens is adapted to receive the excitation light beam exited from the first variable focus lens; and
the control unit is electrically connected to the first variable focus lens and the second variable focus lens, and is adapted to synchronously adjust focal lengths of the first variable focus lens and the second variable focus lens.

2. The illumination system according to claim 1, wherein the excitation light beam passing through the second variable focus lens is parallel light.

3. The illumination system according to claim 1, wherein the first variable focus lens and the second variable focus lens are confocal.

4. The illumination system according to claim 1, wherein a distance between the first variable focus lens and the second variable focus lens is fixed.

5. The illumination system according to claim 1, wherein a diopter of the first variable focus lens and a diopter of the second variable focus lens are both positive.

6. The illumination system according to claim 1, wherein in a time sequence, a diopter of the first variable focus lens is negative, and a diopter of the second variable focus lens is positive.

7. The illumination system according to claim 6, wherein in another time sequence, the diopter of the first variable focus lens is positive, and the diopter of the second variable focus lens is negative.

8. The illumination system according to claim 1, wherein a light spot shape of the excitation light beam passing through the second variable focus lens is circular.

9. The illumination system according to claim 1, further comprising a wavelength conversion wheel, disposed on the transmission path of the excitation light beam passing through the second variable focus lens and adapted to convert the excitation light beam into a converted light beam.

10. A projection device, comprising an illumination system, a light valve and a projection lens, wherein:
the illumination system is adapted to provide an illumination light beam, and comprises an excitation light source, a first variable focus lens, a second variable focus lens, a control unit, and a wavelength conversion wheel, wherein:
the excitation light source is adapted to provide an excitation light beam;
the first variable focus lens is disposed on a transmission path of the excitation light beam;
the second variable focus lens is disposed on the transmission path of the excitation light beam, the first variable focus lens is located between the excitation light source and the second variable focus lens, and the second variable focus lens is adapted to receive the excitation light beam exited from the first variable focus lens;
the control unit is electrically connected to the first variable focus lens and the second variable focus lens, and is adapted to synchronously adjust focal lengths of the first variable focus lens and the second variable focus lens; and
the wavelength conversion wheel is disposed on the transmission path of the excitation light beam passing through the second variable focus lens and is adapted to convert the excitation light beam into a converted light beam, wherein the illumination light beam includes the excitation light beam and the converted light beam;
the light valve is disposed on a transmission path of the illumination light beam and is adapted to convert the illumination light beam into an image light beam; and
the projection lens is disposed on a transmission path of the image light beam and is adapted to allow the image light beam to pass through.
